(19) United States
(12) Patent Application Publication
(10) Pub. No.: US 2006/0191371 A1
(43) Pub. Date: Aug. 31, 2006

(54) Gearbox drive unit

(76) Inventors: Rico Lampert, Sasbach (DE); Walter Haussecker, Buehlertal (DE); Rainer Kurzmann, Achem (DE); Martin Goedecke, Buehl (DE); Peter Froehlich, Karlsruhe (DE); Diyap Bueyuekasik, Buehl (DE)

Correspondence Address: MICHAEL BEST & FRIEDRICH, LLP, 100 E WISCONSIN AVENUE, MILWAUKEE, WI, 53202, US

(21) Appl. No.: 10/566,102

(22) PCT Filed: May 10, 2004
(86) PCT No.: PCT/DE04/00967

§ 371 Date: Jan. 26, 2006

(30) Foreign Application Priority Data
Jul. 31, 2003 (DE) 103350144

(51) Int. Cl. F16H 57/02

(52) U.S. Cl. 74/606 R

(57) ABSTRACT

The invention relates to a gearbox drive unit (1), especially for adjusting movable parts in a motor vehicle. Said unit comprises at least one housing part (2) and at least one fixing dome (6, 7, 8, 9), which is used to secure the gearbox drive unit (1). The housing part (2) comprises a first connection point (45) and at least one other second connection point (46), whereon the fixing dome (6, 7, 8, 9) can be placed. The fixing dome (6, 7, 8, 9) is connected to the housing part (2) at either the first connection point (45) or at the second connection point (46) according to a screw image for fixation of the gearbox drive unit (1).

### PRIOR ART

The invention starts with a gearbox drive unit in accordance with the species of the main claim.

A gearbox drive unit in accordance with the species of the main claim is known from DE 100 19 512 A1.

The gear drive unit known from this printed document features a housing part, on which several fixing domes are provided. The known gearbox drive unit also has a drive, which is embodied as an electromotive drive and is suited especially for window lifter motors or sunroof motors in a motor vehicle. The housing part in this case is built in a modular fashion, i.e., different gear and electronic housings can be joined to different motor housings with a pole pot of the gearbox drive unit. Securing the housing part of the gearbox drive unit is accomplished for example by screwing the housing part to the fixing domes on a part of the body or a seat construction. This therefore determines the spatial arrangement of the gearbox drive unit. The known gearbox drive unit is disadvantageous because a modified screw image, in which the fixing points are modified, requires a new construction of the housing part of the gearbox drive unit. In general, the modularly built gearbox drive unit is suitable only for one specific application.

### ADVANTAGES OF THE INVENTION

In contrast, the gearbox drive unit in accordance with the invention with the features of the main claim has the advantage that, without modifying the housing part of the gearbox drive unit, securing can be accomplished with respect to at least two different screw images. As a result, the gearbox drive unit in accordance with the invention can be used with modified conditions for the same purpose, e.g., as a window lifter motor in different motor vehicles, in which fixation must be accomplished differently. In addition the gearbox drive unit can be used for different purposes, e.g., as a window lifter gearbox drive unit or sunroof gearbox drive unit even if different fixations are required for these two applications, i.e., there are different screw images.

Advantageous developments of the gearbox drive unit disclosed in the main claim are possible as a result of the measures listed in the dependent claims.

It is advantageous that the fixing dome is connected to the housing part by means of dovetail connection. As a result, a continuous displacement of the fixing dome relative to the housing part of the gearbox drive unit can occur within a certain framework so that there is a plurality of fixing possibilities.

The fixing dome is advantageously connected to the housing part of the gearbox drive unit by means of welded connection. As a result, a structurally simple fixation of the fixing dome to the housing part is given, which has high mechanical strength. Alternatively, the fixation of the fixing dome to the housing part can also be accomplished using a screw connection.

It is advantageous that at least one other fixing dome is provided and that the fixing dome and the other fixing dome have a common base body so that they can be connected jointly to the housing part. As a result, manufacturing the gearbox drive unit is simplified considerably since the fixing domes that are connected to one another can be positioned and fixed jointly with respect to the housing.

It is especially advantageous that the housing part has, at least in sections, a circular ring-shaped section, that the common base body of the fixing dome and of the other fixing dome partially surrounds the circular ring-shaped section and can be connected at the first and the second connection point with the circular ring-shaped section. As a result, manufacturing the gearbox drive unit can be further simplified with respect to a preset screw image, because with a preset arrangement of the fixing domes with respect to the base body there is only one degree of freedom, namely rotating the base body relative to the housing part. With respect to different screw images, an adaptation can then be made either by attaching the common base body of the fixing dome to the housing part in a rotationally displaced manner or by manufacturing different base bodies, which provide a different arrangement of the fixing domes and/or a different number of fixing domes, for fixation to the housing part in accordance with the given screw image.

### DRAWINGS

Exemplary embodiments of the invention are depicted in a simplified manner in the drawings and explained in greater detail in the following description. The drawings show:

FIG. 1 A first exemplary embodiment of the gearbox drive unit in accordance with the invention

FIG. 2 A section in the form of an excerpt along the section line in FIG. 1 that is designated by II

FIG. 3 The section in the form of an excerpt depicted in FIG. 2 in accordance with a second exemplary embodiment

FIG. 4 The section in the form of an excerpt depicted in FIG. 2 in accordance with a third exemplary embodiment

FIG. 5 A common base body with several fixing domes in accordance with a fourth exemplary embodiment of the gearbox drive unit

### DESCRIPTION OF THE EXEMPLARY EMBODIMENTS

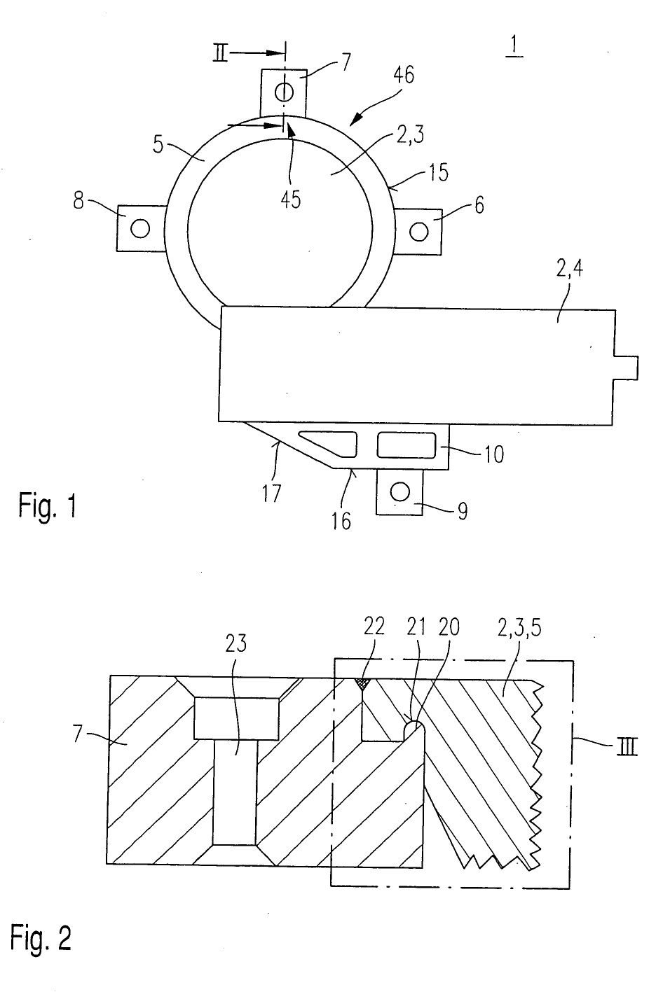

FIG. 1 shows a first exemplary embodiment of a gearbox drive unit 1 of the invention. The gearbox drive unit 1 is used especially for adjusting movable parts in a motor vehicle, e.g., for adjusting a window or a sunroof. However, the gearbox drive unit 1 in accordance with the invention is also suited for other applications.

The gearbox drive unit 1 includes a housing part 2, which is comprised of a gear housing part 3 and a drive housing part 4. The gear housing part 3 of the housing part 2 has a circular ring-shaped section 5, which is interrupted in the area of the drive housing part 4 of the housing part 2. Fixing domes 6, 7, 8 are attached to the gear housing part 3 and a fixing dome 9 is fixed to the drive housing part 4 by means of a fixing element 10, whereby the fixing element 10 is a part of the housing part 2.

The fixing domes 6, 7, 8 can be displaced along the circumference 15 of the circular ring-shaped section 5 before their fixation to the circular ring-shaped section 5 of the gear housing part 3. Because of the displaceability, it is possible to adapt the position of the fixing domes 6, 7, 8 to a preset screw image. The fixing dome 9 can be displaced in an unfixed state along the edge 16 of the fixing element 10 of the housing part 2. In addition, the fixing dome 9 can also be attached to edge 17. Because of the choice of the position of the fixing dome 9 on edge 16 or edge 17, it is possible to adapt to the preset screw image.

The fixation of the fixing dome 7 to the circular ring-shaped section 5 of the housing part 2 is explained in detail in the following on the basis of FIG. 2. Fixation of the fixing domes 6, 8 to the circular ring-shaped section 5 or of the fixing dome 9 to the fixing element 10 is accomplished correspondingly. A smaller or larger number of fixing domes can be provided depending upon the preset screw image.

FIG. 2 depicts a section in the form of an excerpt along the section line in FIG. 1 that is designated by II. Corresponding elements in this and in all other figures are provided with identical reference numbers, thereby making a repetitious description superfluous.

The fixing dome 7 features a projection 20, which engages in a groove 21, embodied on the circular ring-shaped section 5 of the housing part 2. The groove 21 in this connection is embodied circumferentially on the circular ring-shaped section 5. As a result, the fixing dome 7 can be displaced before its fixation circumferentially on the circular ring-shaped section 5 in order to establish the position that corresponds to the preset screw image. In the desired position, an additional connection of the fixing dome 7 to the circular ring-shaped section 5 of the housing part 2 of the gearbox drive unit 1 is accomplished via a welded connection embodied by means of a weld seam 22. The connection of the fixing dome 7 and the housing part 2 is therefore accomplished by a combination of the connection, which is made by the projection 20 engaging in the groove 21, and the connection which is made by the weld seam 22.

Alternatively, the projection 20 and the groove 21 can also be embodied in such a way that the fixing dome 7 snaps into the circular ring-shaped section 5 during attachment to the housing part 2, thereby making a secure connection. The additional weld seam 22 can be dispensed with in this case.

The fixing dome 7 also features a stepped bore hole 23. The stepped bore hole 23 is provided for fixing the fixing dome 7 to a structure by means of a screw. In terms of the structure, it can be a part of the body or a part of the seat construction, for example.

A fixation of the gearbox drive unit 1 is provided by screwing the fixing domes 6, 8, 9 fastened correspondingly to the housing part 2 and the fixing dome 7 just described in detail to the structure.

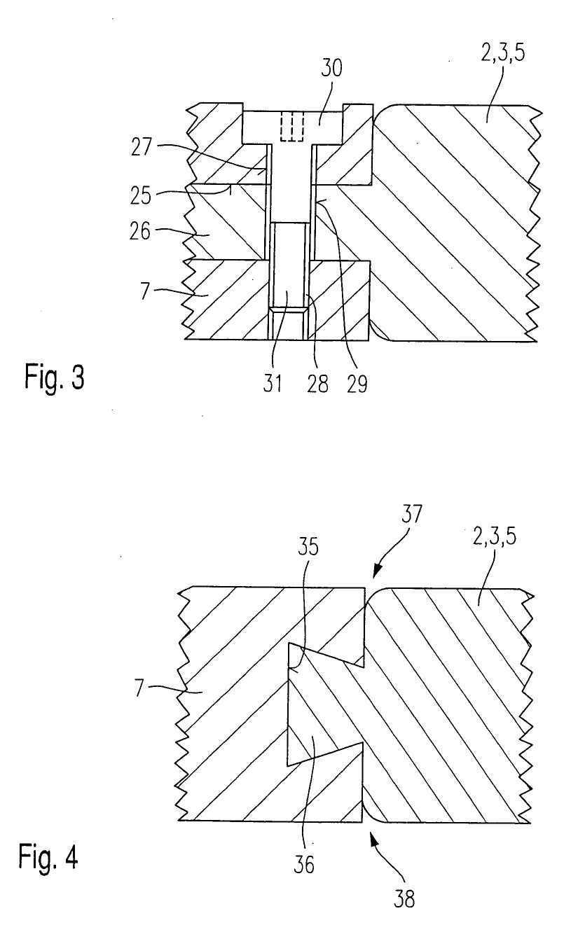

FIG. 3 shows the section of the gearbox drive unit in accordance with the invention designated by III in FIG. 2 in accordance with a second exemplary embodiment of the invention. In the case of this exemplary embodiment, the fixing dome 7 is connected to the circular ring-shaped section 5 of the gear housing part 3 of the housing part 2 of the gearbox drive unit 1 by means of screw connection. A recess 25 is provided for this purpose in the fixing dome 7 into which a projection 26 of the circular ring-shaped section 5 of the housing part 2 can be introduced. The fixing dome 7 also has a bore hole 27 and a threaded bore hole 28. In addition, the projection 26 of the housing part 2 has a bore hole 29. A screw 30 having a threaded section 31 can be screwed into the threaded bore hole 28 through the bore hole 27 in the fixing dome 7 and the bore hole 29 in the projection 26. In a screwed-in state, pulling the projection 26 of the housing part 2 out of the recess 25 of the fixing dome 7 is prevented. A detachable connection between the fixing dome 7 and the gear housing part 3 of the housing part 2 is created in this way.

Alternatively, a recess corresponding to recess 25 can be embodied in the circular ring-shaped section 5 of the housing part 2 and a projection corresponding to projection 26 can be embodied on the fixing dome 7 in order to fix the fixing dome 7 to the circular ring-shaped section 5. In this case, the screw 30 is screwed into the circular ring-shaped section 5.

FIG. 4 shows the section designated by III in FIG. 2 in accordance with a third exemplary embodiment of the invention. In this exemplary embodiment, the fixing dome 7 is connected to the circular ring-shaped section 5 of the gear housing part 3 of the housing part 2 by means of a dovetail connection. A dovetailed groove 35 is provided for this in the fixing dome 7 and the circular ring-shaped section 5 has a dovetailed projection 36 that can be inserted into the groove 35. In order to facilitate the application of the fixing dome 7 on the projection 36 of the circular ring-shaped section 5, the projection 36 is embodied to be interrupted circumferentially. The dovetail connection depicted in FIG. 4 can also be combined with the welded connection depicted in FIG. 2, by preferably providing an additional weld seam in area 37 and/or area 38.

As an alternative to the dovetail connection depicted in FIG. 4, a dovetailed groove corresponding to groove 35 can also be embodied on the circular ring-shaped section 5 of the housing part 2, whereby then a projection corresponding to the projection 36 must be provided on the fixing dome 7. In this case, it is advantageous, in order to facilitate insertion of the fixing dome 7 into the groove of the circular ring-shaped section 5, that the groove is embodied as open rather than dovetailed on at least one section. The fixing dome 7 can then be displaced in the circumferential direction into the desired position.

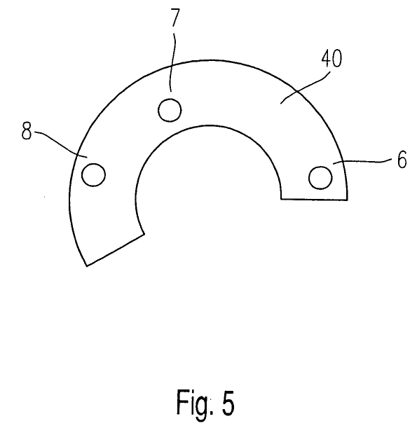

FIG. 5 depicts fixing domes 6, 7, 8, which feature a common base body 40, in accordance with a fourth exemplary embodiment of the invention. The common base body 40 serves to fasten the fixing domes 6, 7, 8 to a circular ring-shaped section 5 of a housing part 2, as depicted in FIG. 1 for example. Because of the common base body 40, the assembly of the gearbox drive unit 1 is facilitated since the position of the fixing domes 6, 7, 8 is preset in a fixed manner relative to one another and they can be connected jointly to the housing part 2 so that fixation of the three fixing domes 6, 7, 8 can be achieved in one assembly step. The fixation of the fixing domes 6, 7, 8 to the circular ring-shaped section 5 of the housing part 2 by means of the common base body 40 can be achieved in a manner as described above on the basis of FIGS. 2 through 4 for example.

The connections of the fixing dome 7 depicted in FIGS. 2 through 4 occur at a first connection point 45, which is depicted in FIG. 1. The circular ring-shaped section 5 is embodied in such a way that fixation on a second connection point 46 can also occur. As a result, before fixation of the fixing dome 7, there is a choice whether the fixing dome 7 is attached to the first connection point 45 or to the second connection point 46. Because of this choice it is possible to adapt to different screw images. When fastening the fixing dome 7 to the circular ring-shaped section 5, which enables continuous displacement, it is possible to adapt to a plurality of screw images. Corresponding to the described fixation of the fixing dome 7 to the circular ring-shaped section 5, the fixing domes 6, 8 can also be connected to the circular ring-shaped section 5 at different connection points. It is advantageous in particular that the fixing domes 6, 7, 8, 9 are embodied to be of the same type so that the fixing dome 6 can be attached for example alternatively to the second connection point 46, which is also suitable for fixing dome 7.

The invention is not limited to the described exemplary embodiments. In particular, instead of the stepped bore hole 23 other means can also be provided to fix the fixing domes 6, 7, 8, 9 to a structure, e.g., the body of a motor vehicle. For example, the fixing domes 6, 7, 8, 9 can also be fixed to the structure using a plug-in connection. Therefore, the term “screw image” used in the application is not meant to be understood in a restricted manner with respect to fixation of the gearbox drive unit 1 by means of the fixing domes 6, 7, 8, 9 that only fixation by means of screw connections is possible, but that plug-in-type connections in particular are also possible.

1. Gearbox drive unit (1), especially for adjusting movable parts in a motor vehicle, comprising at least one housing part (2) and at least one fixing dome (6, 7, 8, 9), which is used to secure the gearbox drive unit (1), characterized in that the housing part (2) comprises a first connection point (45) and at least one other second connection point (46), whereon the fixing dome (6, 7, 8, 9) can be placed, and that the fixing dome (6, 7, 8, 9) is connected to the housing part (2) at either the first connection point (45) or at the second connection point (46) according to a screw image for fixation of the gearbox drive unit (1).

2. Gearbox drive unit according to claim 1, characterized in that the fixing dome (6, 7, 8, 9) features a projection (20), which engages in a groove (21) embodied on the housing part (2) of the gearbox drive unit (1) in order to create the connection between the fixing dome (6, 7, 8, 9) and the housing part (2).

3. Gearbox drive unit according to claim 1, characterized in that the fixing dome (6, 7, 8, 9) is connected to the housing part (2) of the gearbox drive unit (1) by means of a dovetail connection.

4. Gearbox drive unit according to claim 1, characterized in that the fixing dome (6, 7, 8, 9) is connected to the housing part (2) of the gearbox drive unit (1) by means of a welded connection (22).

5. Gearbox drive unit according to claim 1, characterized in that the fixing dome (6, 7, 8, 9) is connected to the housing part (2) of the gearbox drive unit (1) by means of a screw connection.

6. Gearbox drive unit according to claim 1, characterized in that the gearbox drive unit (1) includes several fixing domes (6, 7, 8, 9) of the same type, that a plurality of connection points (45, 46) are provided on the housing part of the gearbox drive unit (1), whereon the fixing domes (6, 7, 8, 9) can be placed, that the fixing domes (6, 7, 8, 9) are connected to the housing part (2) at selected connection points (45, 46), whereby the selected connection points (45, 46) are selected according to the screw image for fixation of the gearbox drive unit (1).

7. Gearbox drive unit according to claim 1, characterized in that at least one other fixing dome (6, 7, 8) is provided and that the fixing dome (6, 7, 8) and the other fixing dome (6, 7, 8) have a common base body (40) so that they can be connected jointly to the housing part (2).

8. Gearbox drive unit according to claim 7, characterized in that the housing part (2) has, at least in sections, a circular ring-shaped section (5), that the common base body (40) of the fixing dome (6, 7, 8) and of the other fixing dome (6, 7, 8) partially surrounds the circular ring-shaped section (5) and can be connected at the first (45) and the second connection point (46) with the circular ring-shaped section (5).

9. Gearbox drive unit according to claim 2, characterized in that the fixing dome (6, 7, 8, 9) is connected to the housing part (2) of the gearbox drive unit (1) by means of a welded connection (22).

10. Gearbox drive unit according to claim 3, characterized in that the fixing dome (6, 7, 8, 9) is connected to the housing part (2) of the gearbox drive unit (1) by means of a welded connection (22).

11. Gearbox drive unit according to claim 2, characterized in that the gearbox drive unit (1) includes several fixing domes (6, 7, 8, 9) of the same type, that a plurality of connection points (45, 46) are provided on the housing part of the gearbox drive unit (1), whereon the fixing domes (6, 7, 8, 9) can be placed, that the fixing domes (6, 7, 8, 9) are connected to the housing part (2) at selected connection points (45, 46), whereby the selected connection points (45, 46) are selected according to the screw image for fixation of the gearbox drive unit (1).

12. Gearbox drive unit according to claim 3, characterized in that the gearbox drive unit (1) includes several fixing domes (6, 7, 8, 9) of the same type, that a plurality of connection points (45, 46) are provided on the housing part of the gearbox drive unit (1), whereon the fixing domes (6, 7, 8, 9) can be placed, that the fixing domes (6, 7, 8, 9) are connected to the housing part (2) at selected connection points (45, 46), whereby the selected connection points (45, 46) are selected according to the screw image for fixation of the gearbox drive unit (1).

13. Gearbox drive unit according to claim 4, characterized in that the gearbox drive unit (1) includes several fixing domes (6, 7, 8, 9) of the same type, that a plurality of connection points (45, 46) are provided on the housing part of the gearbox drive unit (1), whereon the fixing domes (6, 7, 8, 9) can be placed, that the fixing domes (6, 7, 8, 9) are connected to the housing part (2) at selected connection points (45, 46), whereby the selected connection points (45, 46) are selected according to the screw image for fixation of the gearbox drive unit (1).

14. Gearbox drive unit according to claim 5, characterized in that the gearbox drive unit (1) includes several fixing domes (6, 7, 8, 9) of the same type, that a plurality of connection points (45, 46) are provided on the housing part of the gearbox drive unit (1), whereon the fixing domes (6, 7, 8, 9) can be placed, that the fixing domes (6, 7, 8, 9) are connected to the housing part (2) at selected connection points (45, 46), whereby the selected connection points (45, 46) are selected according to the screw image for fixation of the gearbox drive unit (1).

15. Gearbox drive unit according to claim 9, characterized in that the gearbox drive unit (1) includes several fixing domes (6, 7, 8, 9) of the same type, that a plurality of connection points (45, 46) are provided on the housing part of the gearbox drive unit (1), whereon the fixing domes (6, 7, 8, 9) can be placed, that the fixing domes (6, 7, 8, 9) are connected to the housing part (2) at selected connection points (45, 46), whereby the selected connection points (45, 46) are selected according to the screw image for fixation of the gearbox drive unit (1).

16. Gearbox drive unit according to claim 10, characterized in that the gearbox drive unit (1) includes several fixing domes (6, 7, 8, 9) of the same type, that a plurality of connection points (45, 46) are provided on the housing part of the gearbox drive unit (1), whereon the fixing domes (6, 7, 8, 9) can be placed, that the fixing domes (6, 7, 8, 9) are connected to the housing part (2) at selected connection points (45, 46), whereby the selected connection points (45, 46) are selected according to the screw image for fixation of the gearbox drive unit (1).
